(19) United States
(12) Patent Application Publication
(10) Pub. No.: US 2020/0247311 A1
(43) Pub. Date: Aug. 6, 2020

(54) Vehicle Side Light

(71) Applicants: Christopher J. Wehunt, Lancaster, CA (US); Daniel Blake Wehunt, Lancaster, CA (US)

(72) Inventors: Christopher J. Wehunt, Lancaster, CA (US); Daniel Blake Wehunt, Lancaster, CA (US)

(21) Appl. No.: 16/266,091

(22) Filed: Feb. 3, 2019

(51) Int. Cl. B60Q 1/32; B60Q 1/26; B60R 11/04; B60R 1/00; B60Q 1/00; B60Q 1/34; F21S 45/47; F21S 43/14; F21S 43/31; F21S 45/50

(52) U.S. Cl. CPC B60Q 1/32; B60Q 1/2696; B60R 11/04; B60R 1/00; B60Q 1/0023; B60R 2011/004; F21S 45/47; F21S 43/14; F21S 43/31; F21S 45/50; B60Q 1/34

(57) ABSTRACT

A vehicle side light (VSL) that is secured to a side of a vehicle such as a car or truck to provide illumination to an area adjacent the side of the vehicle. The VSL has an attachment plate, a gasket, a heat sink, a power/light emitting diode (LED) board, a reflector, and a cover. At least one LED and preferably multiple LEDs, on the power/LED board provide the illumination. The reflectors has a metallic reflective front surface with outward extending members that create reflecting chambers. At the bottom of each chamber is an opening that allows a LED to illuminate outward to the chamber. The reflector's surface and reflecting chamber design the increase the LEDs illuminative strength. The cover is either a flat front surface with angled side sections, or a convex front surface. The VSL can also function as an auxiliary turn signal with red or yellow LEDs in the side sections. The USLVSL can also include a camera that interfaces with the vehicle's audio/navigation system. While the VSL can be used with may vehicles, the VSL is optimally designed to be secured to a four-door Jeep® vehicle, onto a lower area of a B-pillar, between the Jeep's front and rear doors. To facilitate the securement, the attachment plate has right and left angled sections, with angles of 55° which allows optimal placement on the B-pillar.

### TECHNICAL FIELD

The invention generally pertains to vehicle illumination devices, and more particularly to a vehicle side light that provides illumination to the right and/or left side of a vehicle.

### BACKGROUND ART

In the modern world, the most common means of transportation is by vehicle. There are various types of vehicles, with cars and trucks being the most widely used. Since their initial development, vehicles especially passenger cars have undergone many changes and improvements. While the basic principle of the internal combustion engine that powers most vehicles is still in use, others aspects have significant changes, one of these is vehicle lights.

Throughout the existence of the vehicles there has been an obvious and pronounced need to provide illumination. The illumination helped a driver of a vehicle see the road ahead in dark or low-light conditions, and provides means by which drivers of vehicles could have visual indication of what other vehicles on the road were doing or about to do. The need for vehicle lights has so prevalent that the lights became a requirement for all vehicles.

Typically, vehicle lights include head lights that illuminate the road in front of a vehicle, and indicate/signal when the vehicle is braking or turning, in addition to showing from the rear the presence of the vehicle.

These head lights and rear lights perform well, but there is a deficiency regarding vehicle lights. The front and rear have illumination, but there is no consideration to the sides of a vehicle, particularly a passenger car or truck. There is a need for sidelights, especially when a person(s) is entering or exiting a vehicle in the dark and where driving on a difficult, unfamiliar road at night. For certain vehicles, such as four-wheel drive and vehicles that have been raised, the need is for a side light is even more pronounced.

A search of the prior art did not disclose any literature or patents that read directly on the claims of the instant invention. However, the following U.S. patents are considered related:

| PATENT NO. | INVENTOR | ISSUED |
|---|---|---|
| 5,497,304 | Caine | Mar. 5, 1990 |
| 9,566,901 | Lindsay | Feb. 14, 2017 |
| 2013/0141927 | Kenyon et al | Jun. 6, 2013 |
| 2013/0229820 | Jutila et al | Sep. 5, 2013 |

The U.S. Pat. No. 5,497,304 patent discloses a side warning lights for an elongated motor vehicle such as a truck trailer. The side warning lights include first and second plurality of lights on both sides of the vehicle the lights are energized so that under normal operating conditions one of the plurality of lights will be energized while under other operating conditions the other plurality of lights will be energized. A third plurality of lights may be included which will operate in conjunction with the conventional directional turning lights of the vehicle.

The U.S. Pat. No. 9,566,901 patent discloses side marker lighting systems, methods of providing side marker lighting, and vehicles including the same. The side marker lighting system includes a light emitting module having a plurality of light emitting diodes (LED), a sensor module and a master controller to receive data from the sensor module. The data indicates a vehicle is located the vicinity of the side marker lighting system, determines that the vehicle is moving toward the system at an angle, determines location coordinates of the vehicle determines a direction of light and aims the light at the vehicle and activates the LEDS to a produce a collective beam that corresponds to the direction.

The 2013/0141927 publication discloses a light emitting dioder (LED) perimeter lamp assembly that includes a housing with a receiving pocket formed therein for receiving a circuit board with a plurality of LEDS1. A culminating lens having a plurality of light directing elements is positioned within the receiving pocket such that light emitted from the LEDs passes through the elements. A perimeter lamp is installed on the bottom side of the lamp housing at an acute angle to a ground surface such that light emitted by the LEDS is projected onto the ground surface.

The 2013/0229820 publication discloses a lighting system for an exterior panel of a vehicle that includes a molding that is affixed to the exterior panel. The molding includes a feature configured to retain a light string and fix the light string relative to the molding. The light string is connected to an electric system of the vehicle and is activated to illuminate an area surrounding the exterior panel.

For background purposes and indicative of the art to which the invention relates, reference may be made to the following remaining patents found in the patent search.

| PATENT NO. | INVENTOR | ISSUED |
|---|---|---|
| Re 34,275 | Ramsey | Jun. 8, 1993 |
| D489,466 | Dohogne et al | May 5, 2004 |
| D492,047 | Dohogne et al | Jun. 22, 2004 |
| 2,159,532 | Prance | May 23, 1939 |
| 4,964,022 | Lane | Oct. 16, 1990 |
| 5,099,401 | Kondo et al | Mar. 24, 1992 |
| 5,307,211 | Schmidt et al | Apr. 26, 1994 |
| 6,183,108 | Herold | Feb. 6, 2001 |
| 6,523,976 | Turnbull et al | Feb. 25, 2003 |
| 6,609,813 | Showers et al | Aug. 26, 2003 |
| 6,776,504 | Sloan et at | Aug. 17, 2004 |
| 6,910,788 | Jones | Jun. 28, 2005 |
| 7,448,768 | Sloan et al | Nov. 11, 2008 |
| 8,231,255 | Konishi | Jul. 31, 2012 |
| 8,480,272 | Day | Jul. 9, 2013 |
| 8,550,676 | Ohno et al | Oct. 8, 2013 |
| 8,608,356 | McGean | Dec. 17, 2013 |
| 8,947,223 | McLoughlin et al | Feb. 3, 2015 |
| 9,796,325 | Salter et al | Oct. 24, 2017 |
| 2009/0310352 | Chang | Dec. 17, 2009 |
| 2010/0172140 | Chen et al | Jul. 8, 2010 |
| 2011/0096561 | Owada | Apr. 28, 2011 |

### DISCLOSURE OF THE INVENTION

A vehicle side light (VSL) that is secured onto a vehicle, such as a car or truck, side surface to illuminate the area perpendicular and adjacent the vehicle. The VSL is secured by either permanent or non-permanent attachment means, or the VSL can be integrally attached during the vehicles manufacturing process. The main elements of the VSL are an attachment plate, a gasket, a heat sink, a power/LED board, a reflector and a cover. The illumination is provided by at least one, and preferably multiple LEDs, although illumination means such as an incandescent bulb could also be used. The reflector has a metallic silver highly-reflective front surface with outward extending members that create reflecting chambers, with one chamber for each LED.

In a first design, the cover has angled side sections, and in a second design the cover has a convex front surface. There are openings in the power/LED board and attachment plate. The openings allow wires from the board to pass through the plate into the vehicle, where the vehicle's existing power system is connected to the VSL.

To increase the functionally of the VSL additions and modifications can be used. A light bar can extend longitudinally along a side edge of the VSL. The light bar can provide additional illumination and an interesting/pleasing aesthetic appearance.

The side edges of the VSL can be modified to function as turn indicators, using yellow or red LEDs. A design of the VSL can use two LEDs, one on each side, with score marks extending from the LEDs across the reflector's front surface. The score marks direct the illumination from the LEDs on the entire front surface of the reflector. The score marks could also spell words that would be illuminated and visible on the VSL.

Finally, a camera can be attached to the VSL. The camera interfaces with the vehicle's audio/navigation system and shows an image(s) from the side of the vehicle on the audio/navigation system's display screen.

It is important to note that while the VSL can be used with many types of vehicles, a specific use is on a four-door Jeep® vehicle. The attachment plate has angled side sections with an angle of 55°. This particular angle is optimally utilized to allow the VSL to be secured onto a lower area of the Jeep's B-pillar between the front door and rear door.

In view of the above disclosure, the primary object of the invention is to provide a vehicle side light that illuminates an area adjacent the side(s) of vehicle.

In addition to the primary object, it is also an object of the invention to provide a vehicle side light that:
is easy to install,
requires no maintenance other than replacing a non-working LED,
requires minimal power,
significantly increase the safety of a person entering or exiting a vehicle, especially in dark/low-light environments,
can be sold as an aftermarket installable kit or as an OEM component of a vehicle,
can increase the aesthetic appearance of a vehicle,
can be permanently or a non-permanently secured to a vehicle,
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic exploded view showing a vehicle side light having a cover with a right angled side section and a left angled side section, on the two angled sections extending rearward and outward from the side edge of the cover's front surface and an attachment plate with angled side sections.

FIG. 2 is a top exploded view showing the vehicle side light having the cover with angled side sections.

FIG. 3 is a right side exploded view showing the vehicle side light having the cover with angled side sections.

FIG. 4 is a front elevational view showing the vehicle side light having the cover with angled side sections.

FIG. 5 is a rear elevational view showing the vehicle side light with the attachment plate having angled side section.

FIG. 6 is an orthographic exploded view showing the vehicle side light having a cover with a convex front surface.

FIG. 7 is a top plan view showing the vehicle side light cover with a convex front surface.

FIG. 8 is an elevational front view showing the vehicle sidelight with a camera on the attachment plate.

FIG. 9 is a front elevational view showing the vehicle side light having at least one LED on the right side and at least one LED on the left side, with score marks extending along the front surface of a reflector.

FIG. 10 is an elevational view showing the vehicle side light integrally attached to a cowl of a four-door Jeep vehicle.

### BEST MODE FOR CARRYING OUT THE INVENTION

The best mode for carrying out the invention is presented in terms that disclose a preferred embodiment, with multiple design configurations, of a vehicle side light (VSL) 10. Many types of vehicles such as cars, truck and motorcycles utilize illumination. In fact, for most cases it is a legal requirement that a vehicle has operable illumination means, typically, these include headlights for illuminating the road or are in front of a vehicle, and rear light/tail lights that function as indicators, e.g., a brake light, for a vehicle(s) behind another vehicle.

For their intended purpose, headlights and tail lights (as well as other lights such as turn indicators) function well. In addition to the front and rear of a vehicle there are other areas where a person will be when using vehicle. The most frequent area is a side of a vehicle. In order to enter or exit a vehicle a person usually must do so from the side. During night time or in low-light environments, it can be difficult to see the ground or any object on the side of a vehicle. The VSL 10 offers a solution to this problem by providing an illumination that is directed outward from the side(s) of a vehicle.

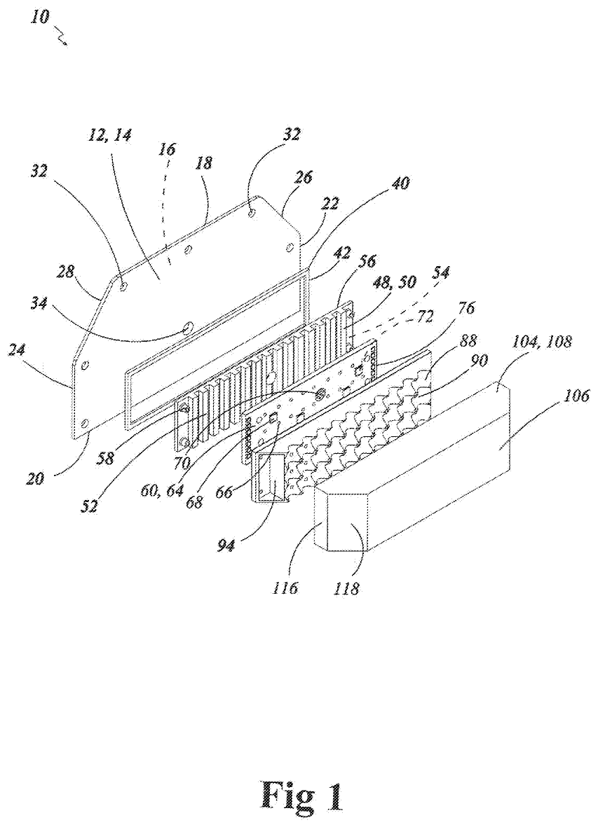

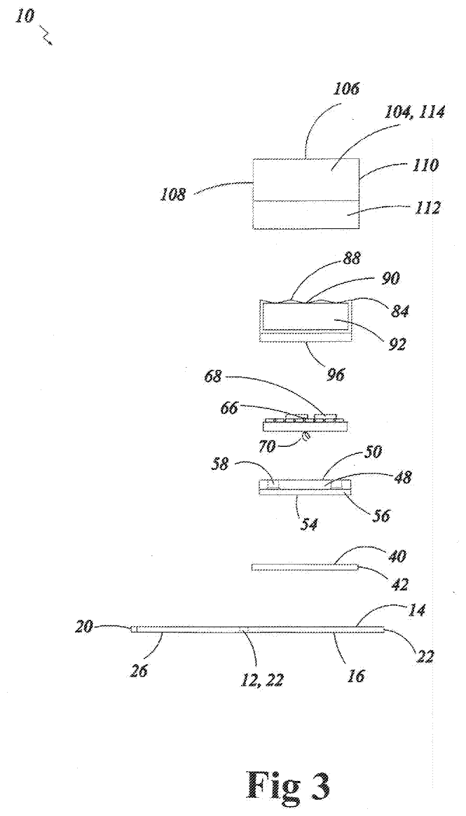

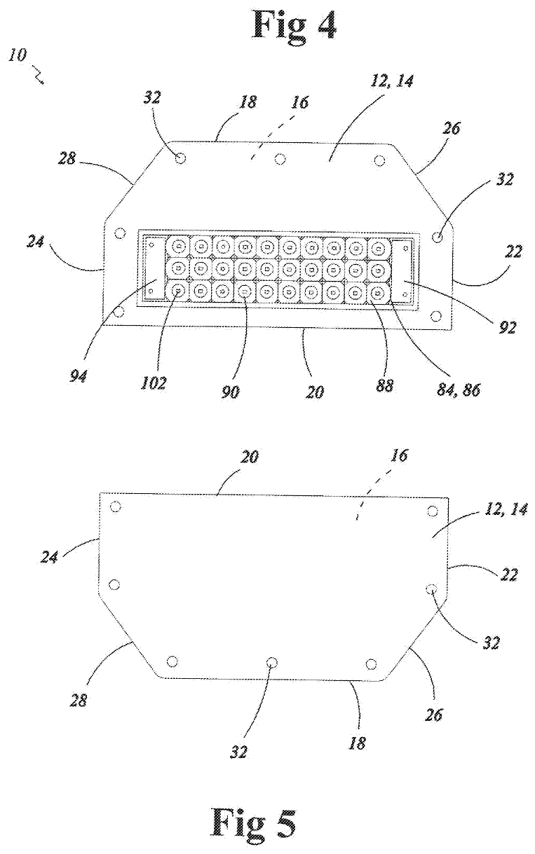

The VSL 10, as shown in FIGS. 1-9, is comprised of the following major elements: an attachment plate 12, a heat sink 48, a power/light emitting diode (LED) board 62, a reflector 84, and a cover 104. The elements of the VSL 10 can have various shapes which are typically determined by the type of vehicle on which the VSL 10 is used and the location on the vehicle's side that the VSL 10 is placed. For the purpose of this disclosure, a substantially rectangular VSL 10 is described in the text and shown in the drawings.

As shown in FIGS. 1-6, the attachment plate 12 has a front surface 14, a rear surface 16, an upper edge 18, a lower edge 20, a right edge 22, and a left edge 24. The VSL 10 is optimally designed to be used on a four-door Jeep vehicle. On a four-door Jeep, the VSL 10 is attached to a lower area of the B-pillar between the front and rear doors. To facilitate this attachment location, the attachment plate 12 has a right angled section 26 in lieu of the upper right corner, and a left angled section 28 in lieu of the upper left corner. The two angled sections 26,28 allow the VSL 10 to fit perfectly between the two side doors, thereby providing illumination to the side(s) of the Jeep® or other vehicle and enough illumination for both driver/front passenger and rear passenger(s).

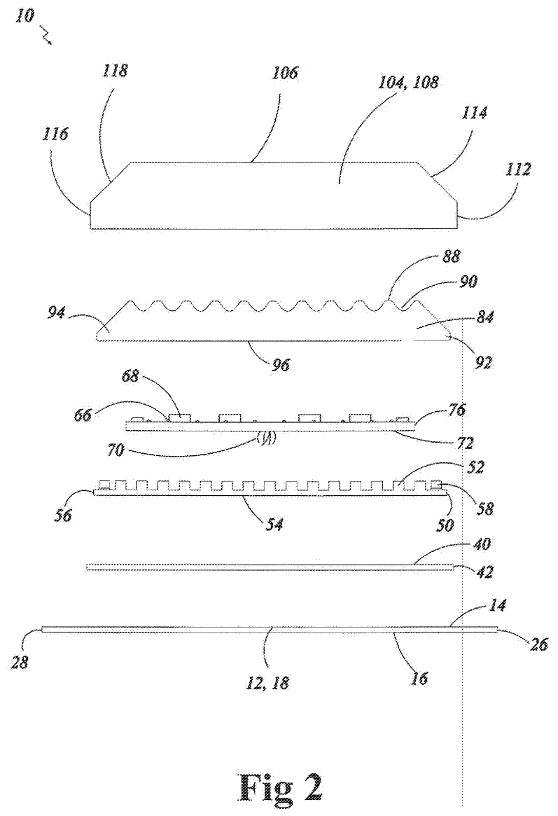

The attachment plate 12 can be made of a various materials including metal, plastic or a composite, with metal preferred. The plate 12 can be permanently or semi-permanent secured onto the vehicle by attachment means 36 which can include at least one screw, at least one bolt and nut, welding or an adhesive such as industrial epoxy. To facilitate the securement of the plate 12 with certain attachment means, a plurality of bores 32 are located on the plate 12. Also, to allow required wiring to pass through the plate 12, an opening 34 is located on the plate 12. Following along the side edges, on the plate's 12 front surface is a gasket 40 with a perimeter edge 42, as shown in FIGS. 1 and 2. The gasket 40 keeps moisture and dirt from entering the VSL 10.

Attached to the front surface 14 of the plate 12 is the heat sink 48 which has a front surface 50 with multiple outward extending members 52, a rear surface 54 and a perimeter edge 56. Attachment means 58 such as screws, bolts and nuts or an adhesive are utilized to secure the heat sink 48 on the plate 12, and the heat sink 48 functions to absorb and disperse heat that is generated from the VSL 10.

In front of, and secured 60, the heat sink 48 is the power/LED board 52. As shown in FIGS. 1-4, the power/LED board 62 comprises a front surface 64 on which there are at least one LED 66 (although multiple LEDs are commonly used), electrical components 68 that facilitate the use of the vehicle's existing power system to provide power to the VSL 10 via power wires 70 that extends through an opening 74 on the board 62, through the opening 34 on the plate 12 and into the vehicle, a rear surface 72 and a perimeter edge 76. Attachment means 78 for securing the board 62 onto the heat sink also includes screws, bolts and nuts or an adhesive.

As shown in FIGS. 1-4, interfacing with the front surface 64 of the board 62 is the reflector 84 comprising a front surface 86 with outward extending members 88. The front surface 86 is made of a shiny silver material for optimal reflection and outward projection of light from the LEDs. Between multiple outward extending members 88 is a reflecting chamber 90 created from the positions of side of the outward extending members 90. Located at the bottom of the interior of each chamber 90 is an LED opening 102 that allows an LED to illuminate outward, reflecting and dispersing from the sides within the chamber. The number and orientation of outward extensive member and reflecting chambers is determined by the number and positions of the LEDS on the board. The reflector 84 also has a right side section 92 and a left side section 94, both of which have indented reflective inner surfaces and LED openings. The right and left side sections 92,94 can be used as conventions illumination means as an element of the VSL. Alternately the right and left side section 92,94 an be used as turn indictors. By interfacing the VSL 10 electronic circuit with the vehicle's existing on-off blinking circuit, the two sections 92,94 can easily function as auxiliary turn indicators. When used as turn indicators it is preferably to use yellow or red LEDs in the side sections 92,94. As these colors are the conventional colors used. That reflector 84 has a rear surface 96 and utilizes attachment means 98 that are same as these disclosed for the previous elements.

Enclosing the above elements is a cover 104. As shown in FIGS. 1-3, the cover 104 comprises a front surface 106, an upper surface 108, a lower surface 110, a right surface 112 with a right angled section 114, and a left surface 116 with a left angled section 118. Two angled sections 114,118 edge inward and forward, thereby causing the front surface to occupy a smaller area than the open rear of the cover 104. This cover design is facilitated by the use of the reflector and the two angled side sections, the contours of the cover 104 follow the contour of the reflector and side sections. The cover can be secured by attachment such as adhesive, or the cover 104 can be press-fit onto/over the reflector. While the press-fit does provide secure attachment, it also allows the cover to be easily removed. This is important because the LEDs are preferably user-replaceable, and removing the cover allows a person to access the LEDs.

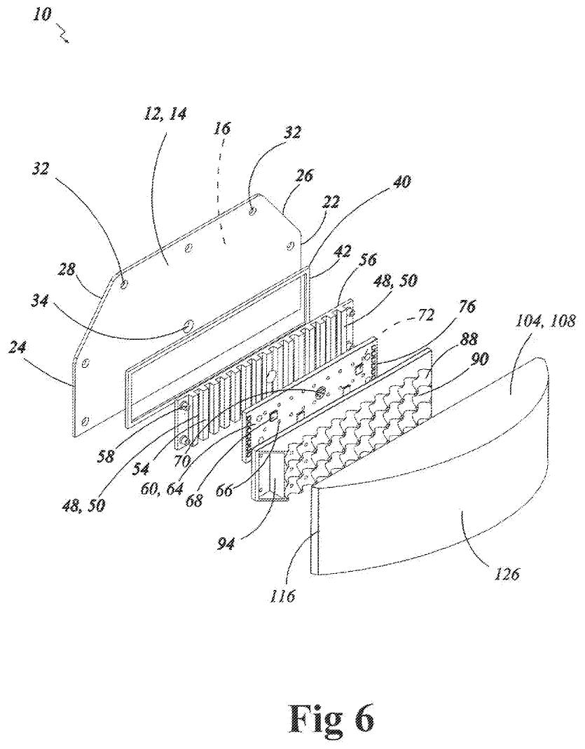

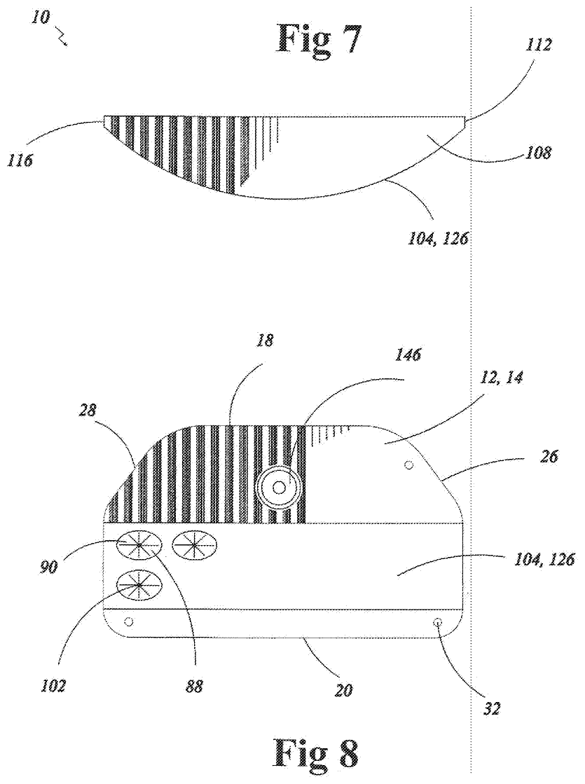

In a first alternate design, the VSL 10 has a cover with a curved front 126, as shown in FIGS. 6 and 7, the curvature is convex and appears as a bifurcated ellipse in profile. Other than the front cover design all of the elements of the VSL 10 are the same in the second design as in the first design.

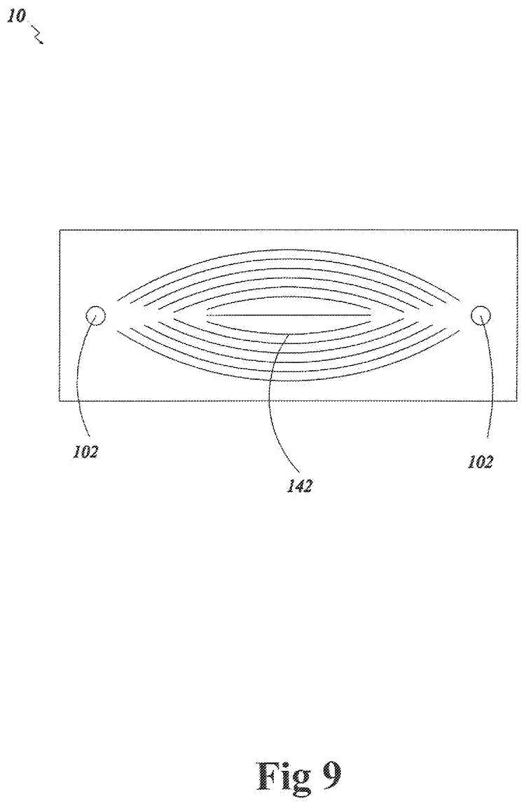

In another design configuration, the VSL utilizes two LEDS, with one on each side edge. As shown in FIG. 9, in this design there are score marks 142 cut into the reflector's front surface 80. The score marks 142 allow the illumination from the LEDS to be directed across the entire front surface 86 of the reflector 84.

If desired, a lower bar 138 can extend longitudinally along the lower edge of the VSL 10. The light bar can be made of multiple LEDs placed directly next to each together and provides additional illumination as well as an aesthetic appearance.

A final addition to the VSL 10 is a camera 146. As shown in FIG. 8, the camera 146 is preferably located on the attachment plate 12 above the cover and elements within. The camera 146 interfaces with the vehicle's existing audio/navigation system and show an image of the area on the side(s) of the vehicle on the audio/navigation system's display screen.

The VSL 10 can be turned on or off by a dedicated button (or switch) within the vehicle of the VSL 10 can be turned on or off when the vehicle's head light/rear lights are automatically on manually turned on and off. An on//off control can also be placed on a vehicle for when the VSL 10 an original equipment manufacturer (OEM) part included when the vehicle is built.

Also, the duration the VSL remains illuminated can be selectively programmed. His functionality is important because it is often beneficial to have the VSL 10 remain illuminated after the other vehicle lights have (been) turned off.

To increase the convenience of using/having the VSL 10, a motion sensor can be placed on the VSL 10, preferably on the attachment plate 12. The motion sensor turns the VSL 10 on when a person corns within a certain distant of the vehicle/VSL. The LEDs can also be programmed to display words or shapes. Statements/phrases can be produced by programming a series of words to be displayed in a particular order.

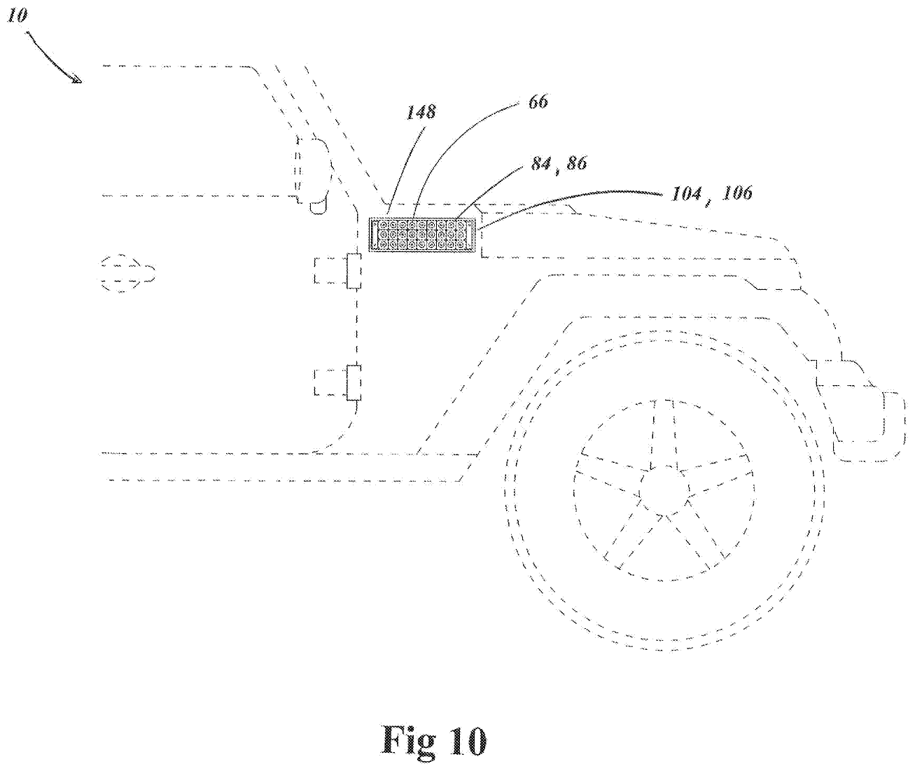

In another alternate configuration, the VSL is located on a vertical side section of a vehicle cowl. As shown in FIG. 10, the side section of the cowl is a part of a vehicle panel that extends horizontally between the rear edge of the hood and the lower edge of the windshield, and continues vertically downward on the side of the vehicle. When the VSL is located on the cowl 148, the rear attachment plate 12 is not required, since the VSL is integrally attached to the cowl 148. The cowl attached VSL produces side-directed illumination that originates from a location above the B-pillar attached configuration. Both configurations produce side produce side illumination, the choice of which to use is typically determined by the requirements and desire of the vehicle owner.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A vehicle side light (VSL) comprising:
an attachment plate having:
a front surface,
a rear surface,
an upper edge,
a lower edge,
a right edge,
a left edge,
a right angled section,
a left angled section,
bores,
an opening,
attachment means,
a gasket with a perimeter edge,
a heat sink having:
a front surface with outward extending members,
a rear surface,
a perimeter edge,
attachment means,
a power/LED board having:
a front surface,
at least one light emitting diode (LED),
electrical components connected to power wires,
a rear surface,
an opening,
a perimeter edge,
a reflector having:
a front surface comprising:
outward extending members,
reflecting chambers,
LED openings,
a right section,
a left section
a rear surface,
attachment means and
a cover comprising:
a front surface,
an upper surface,
a lower surface,
a right surface,
a right angled section,
a left surface, and
a left angled section, the VSL configure to be attached onto a side surface of a vehicle to illuminate a side area adjacent the vehicle,

2. The vehicle side light of claim 1, wherein the attachment plate is made of a material selected from the group consisting of metal, plastic and a composite.

3. The vehicle side light of claim 1, wherein the attachment means is selected from the group consisting of at least one screw, at least one bolt and nut, welding, an adhesive, at least one rivet, and a bolt with a threaded insert.

4. The vehicle side light of claim 1, wherein the attachment means is comprised of factory integration, resulting in the VSL configured as an integral element of a vehicle side panel.

5. The vehicle side light of claim 4, wherein the vehicle side panel comprises a vertical side section of a vehicle cowl.

6. The vehicle side light of claim 1, configured for attachment to a lower area of a vehicle B-pillar, between a front side door and a rear side door.

7. The vehicle side light of claim 1, wherein the attachment plate right and left angled section each have a 55° angle to specifically facilitate the attachment of the VSL to a B-pillar of a four-door Jeep® vehicle.

8. A vehicle side light (VSL) comprising:
an attachment plate having:
a front surface,
a rear surface,
an upper edge,
a lower edge,
a right edge,
a left edge,
a right angled section,
a left angled section,
bores,
an opening,
attachment means,
a gasket with a perimeter edge,
a heat sink having:
a front surface with outward extending members,
a rear surface,
a perimeter edge,
attachment means,
a power/LED board having:
a front surface,
at least one light emitting diode (LED),
electrical components connected to power wires,
a rear surface,
an opening,
a perimeter edge,
a reflector having:
a front surface comprising:
outward extending members,
reflecting chambers,
LED openings,
a right section,
a left section
a rear surface,
attachment means and
a cover comprising a convex front surface, the VSL configured to be attached onto a side surface of a vehicle to illuminate a side area adjacent the vehicle.

9. The vehicle side light of claim 8, wherein the attachment plate is made of a material selected from the group consisting of metal, plastic and a composite.

10. The vehicle side light of claim 8, wherein the attachment means is selected from the group consisting of at least one screw, at least one bolt and nut, welding, an adhesive, at least one rivet, and a bolt with a threaded insert.

11. The vehicle side light of claim 8, wherein the attachment means is comprised of factory integration, resulting in the VSL configured as an integral element of a vehicle side panel.

12. The vehicle side light of claim 8, wherein the vehicle side panel comprises a vertical side section of a vehicle cowl.

13. The vehicle side light of claim 8, configured for attachment to a lower area of a vehicle B-pillar, between a front side door and a rear side door.

14. The vehicle side light of claim 8, wherein the attachment plate right and left angled section each have a 55° angle to specifically facilitate the attachment of the VSL to a B-pillar of a four-door Jeep® vehicle.

15. The vehicle side light of claim 8, wherein the at least one LED is user replaceable.

16. The vehicle side light of claim 8, further comprising a camera directed outward to the area adjacent the side of the vehicle, wherein the camera is secured to the attachment plate and is configured to integrate with a vehicle's audio and navigation system.

17. The vehicle side light of claim 8, further comprising an on-off blinking circuit that configures LEDs on side edges to function as right and left turn indicators.

18. A vehicle side light (VSL) comprising:
an attachment plate having:
a front surface.
a rear surface,
an upper edge,
a lower edge,
a right edge,
a left edge,
a right angled section,
a left angled section,
bores,
an opening,
attachment means,
a gasket with a perimeter edge,
a heat sink having:
a front surface with outward extending members,
a rear surface,
a perimeter edge,
attachment means,
a power/LED board having:
a front surface,
a right light emitting diode (LED),
a left light emitted diode (LED),
electrical components connected to power wires,
a rear surface,
an opening,
a perimeter edge,
a reflector having:
a front surface,
a right LED opening,
a left LED opening,
score marks,
attachment means, and
a cover comprising a convex front surface, the VSL configured to be attached onto a side surface of a vehicle to illuminate a side area adjacent the vehicle.

19. The vehicle side light of claim 18, wherein the attachment plate is made of a material selected from the group consisting of metal, plastic and a composite.

20. The vehicle side light of claim 18, wherein the attachment means is selected from the group consisting of at least one screw, at least one bolt and nut, welding, an adhesive, at least one rivet, and a bolt with a threaded insert.

21. The vehicle side light of claim 18, wherein the attachment means is comprised of factory integration, resulting in the VSLVSL configured as an integral element of a vehicle side panel.

22. The vehicle side light of claim 18, wherein the vehicle side panel comprises a vertical side section of a vehicle cowl.

23. The vehicle side light of claim 18, configured for attachment to a lower area of a vehicle B-pillar, between a front side door and a rear side door.

24. The vehicle side light of claim 18, wherein the attachment plate right and left angled section each have a 55° angle to specifically facilitate the attachment of the VSL to a B-pillar of a four-door Jeep® vehicle.
